(19) United States
(12) Patent Application Publication
(10) Pub. No.: US 2020/0345468 A1
(43) Pub. Date: Nov. 5, 2020

(54) ENGAGE FLOSSING DEVICE

(71) Applicant: Michael BAUMAN, Jessup, PA (US)

(72) Inventor: Michael BAUMAN, Jessup, PA (US)

(21) Appl. No.: 16/403,447

(22) Filed: May 3, 2019

(51) Int. Cl. A61C 15/04

(52) U.S. Cl. CPC A61C 15/046; A61C 15/043

(57) ABSTRACT

A flossing device 100 is described having a flossing head 130 connected to a handle 110 The flossing head 130 includes a pair of elongated side posts 135 each having a proximal end and a distal end, a cross bar attaching the proximal ends of the side posts 135, an end ribbon 141 stretched between distal ends of the side posts 135 and a panel 139 connected between the side posts 135 but spaced away from the end ribbon 141 creating a gap 137 which collects and removes tartar and food particles which are scraped off of the surface of the user's teeth. The unique design allows the handle to hold the flossing head 130 at the proper angle to insert it between the user's teeth. The panel 139 may be constructed from a plurality of parallel flossing ribbons, flossing string, or a combination of both. The panels 139 may be embossed or die cut to increase abrasion and efficiency.

### CROSS REFERENCE TO RELATED APPLICATIONS

Not applicable.

### FIELD

The current invention relates to a flossing device which more efficiently cleans teeth surfaces, and more specifically, to a flossing device which more efficiently cleans teeth surfaces simultaneously over a large part of their surfaces.

### BACKGROUND

### Snapping

FIG. 1A illustrates two of a user's lower teeth, tooth 3 and tooth 5 which are adjacent each other. The space between them is an interdental space 7. The user forces a line of taut floss 13 downward as indicated by the arrow labeled “A” into the interdental space 7 to clean out food particles and tartar attached to the surface of teeth 3, 5.

In FIG. 1B, the floss 13 reaches a narrowing 9 in the interdental space 7 and gets caught. Therefore, the user increases the force A on the floss 13 to pull it through the narrowing 9.

In FIG. 1C, the floss 13 passes through the narrowing 9, then unexpectedly encounters little resistance after having passed through narrowing 9.

Before the user can react and reduce the force A on the floss 13, floss 13 receives little resistance and quickly travels through the remaining interdental space 7.

The user typically cannot reduce the force A exerted quickly enough and the floss is quickly snapped into the gum line 11 with excessive force and typically cuts into the user's gums. This causes cuts, bleeding and impregnation of bacteria into the user's gums and bloodstream.

### Tensioning Floss

Using a single line of floss requires one to tightly hold the floss 13 between their hands while pulling the floss 13 between the teeth 3, 5 as shown in FIGS. 1A-1C. If the floss is not taut enough, it cannot be pulled between teeth having a small gap between them. It is difficult to hold the floss taut while trying to manipulate it between user's teeth.

### Release of Tartar/Food Particles

In flossing, only a single strand scrapes a superficial layer of tartar/food particles off the tooth surface and typically passes under and past the removed file/food particle. The removed food particles are allowed to fall down into the interdental space 7, possibly getting trapped between the user's gum and tooth at gum line 11. This causes worse problems. It would be beneficial to have a structure which catches or holds and removes the tartar/food particles that are removed from the surface of the user's teeth during flossing.

### Proper Angle

Also, at times it is difficult to hold the floss 13 at a proper angle to insert it between some of the user's teeth 3, 5 since there are times that the user cannot fit his/her hands into his/her mouth to get the proper angle.

A tooth has a complex surface. If floss is applied from the optimal direction at the optimal angle, it can wrap around a portion of this surface and conform as the surface changes. However, due to the limited access angles from which a user can pull the floss, it is difficult to bow it around most of the tooth surface so as to scrape a large percentage of the outer surface of a tooth. Therefore, there are times that the user cannot clean as much of the tooth surface as is desired.

Currently, there is a need for a device that holds floss tightly, can work at various angles, can collect and hold tartar and food particles, and prevents cuts to gums.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted to facilitate a less obstructed view of these various example embodiments.

FIGS. 1A-1C illustrate inadvertent cutting into a user's gums when using conventional floss.

FIG. 2 is a view of a side of an embodiment of a novel flossing device according to the current invention.

FIG. 3 is a view of a back side of an embodiment of a novel flossing device according to the current invention.

FIG. 4 is a view of a front side of an embodiment of a novel flossing device according to the current invention.

FIG. 5 is a perspective view of an embodiment of a novel flossing device according to the current invention as it attaches to a removable and disposable cleaning head.

FIG. 6A is a perspective view of an embodiment of a novel removable and disposable cleaning head compatible with the current invention.

FIG. 6B is a view from a side of the removable and disposable cleaning head shown in FIG. 6A.

FIG. 7A shows an exploded view of the parts of one embodiment of a release mechanism according to the current invention.

FIG. 7B shows the release mechanism of FIG. 7A partially assembled.

FIG. 7C shows the release mechanism of FIG. 7A fully assembled.

FIG. 7D shows the fully assembled release mechanism of FIG. 7C attached to a handle.

FIGS. 8A-8C illustrate the functioning of the current invention to prevent the inadvertent cutting of a user's gums while flossing.

FIGS. 9A-9D illustrate the functioning of the current invention in removing debris from the user's teeth.

FIGS. 10A-10F illustrate various cross-sectional shapes that may be employed in the panel.

FIGS. 11A-11B illustrate panels that may be used, having die cut patterns.

FIG. 12A illustrates alternative embodiment of a panel having a plurality of parallel embossed ribbons creating an embossed pattern.

FIG. 12B illustrates alternative embodiment of a panel having a plurality of parallel embossed strings creating an embossed pattern.

FIG. 13A is a side elevational view of another embodiment of a flossing device according to the current invention.

FIG. 13B is a top plan view of the flossing device of FIG. 13A.

FIG. 14A is a front elevational view of another embodiment of a disposable flossing head according to the current invention.

FIG. 14B is a side elevational view of the disposable flossing head of FIG. 14A.

FIG. 15A is a top plan view of another docking system with a portion of the body removed.

FIG. 15B is a cross-sectional, front view of the docking system of FIG. 15A.

FIG. 16 shows two disposable embodiments of the flossing device with one having a flat handle which is parallel to the panel and one having a flat handle which is perpendicular to the panel.

FIG. 17 is a perspective view of the flossing device having a handle which is perpendicular to the flossing head similar to that shown at the top of FIG. 16.

FIG. 18 is another perspective view of a flossing device of FIG. 17 having a handle which is perpendicular to the flossing head 130.

FIG. 19 is a side elevational view of the flossing device of FIGS. 17 and 18.

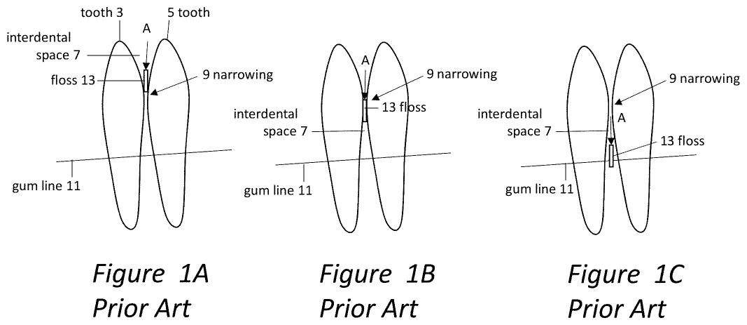

### SUMMARY

The current invention may be embodied as a flossing device 100, having a handle 110 with a grip end 113 and a head end 111, a flossing head 130 connected to the handle 110.

The flossing head includes a pair of elongated side posts 135 each having a proximal end and a distal end, a cross bar attaching the proximal ends of the side posts 135, an end ribbon 141 stretched between distal ends of the side posts 135; and a panel 139 connected between the side posts 135 but spaced away from the end ribbon 141.

The panel 139 of the flossing device 100 is comprised of a plurality of flossing ribbons. The panel 139 may also have a rough surface, or an embossed surface. The panel 139 may also include a surface having a plurality of recesses. The flossing head 130 can be fixed at a predetermined angle with respect to the handle 110. The flossing head 130 may also be removable, replaceable, or disposable. The end ribbon 141 and panel 139 of the flossing head 130 may be spaced apart less than half of the height of an average adult tooth.

Alternatively, the end ribbon 141 and panel 139 of the flossing head 130 are spaced apart less than half of the height of an average child's tooth for a child's version of the flossing device 100. The flossing device 100 may also have a neck 133 attached to the flossing head 130, a locking knob 131 attached to the neck 133, and a release mechanism 160 in the handle 110 adapted to receive the locking knob 131 and neck 133 and retain them.

The release mechanism 160 is adapted to releasably attach the flossing head 130 to the handle 110.

The release mechanism 160 is made up of at least two lever pieces 165, 167 each having a release button 121, and a retaining bar 170 attached to each release button at a flex point 173. The retaining bar 170 includes a knob grip 171 at a first end, and a bar extension 177 at a second end, wherein when the release buttons are pushed toward a center line of the handle 110, it causes the bar extensions 177 to move towards the center line but causes the retaining bar 170 to pivot at the flex point 173 and cause the knob grips to move outward from a center line, releasing a flossing head.

The current invention may also be embodied as a method of cleaning a user's teeth 3, 5, having the steps of providing a flossing device 100 having an elongated handle 110 with a flossing head 130 extending from the handle 110 in a substantially perpendicular direction which is allowed to be rotated about a pivot and fixed at a desired angle. The cleaning head has an end ribbon stretched between two side posts spaced away from a panel 139 extending between the side posts creating a gap 137, adjusting a rotation angle of the flossing head 130 to fit in at least one interdental space 7, manipulating the handle 110 to press the flossing head 130 into the interdental space 7 so as to remove debris 15 and collect it in the gap 137; and removing the flossing head 130 from the interdental space 7 so as to remove the debris 15 collected in gap 137.

The method may also include, after pressing the flossing head 130 into the interdental space 7, the step of moving the flossing head 130 to have the end ribbon 141 and the panel 139 slide against the tooth surface and scrape away additional debris 15.

The method may also include the steps of removing the used flossing head 130, disposing the used flossing head 130, and attaching a new flossing head 130.

The current invention may also be embodied as a disposable flossing device 100, having a disposable handle 110 having a grip end 113 and a head end 111; a disposable flossing head 130 connected to the handle 110 having a pair of elongated side posts 135 each having a proximal end and a distal end, an end ribbon 141 stretched between distal ends of the side posts 135; and a panel 139 connected between the side posts 135 but spaced away from the end ribbon 141.

The panel 139 of the flossing device 100 may be made from a plurality of flossing ribbons. The panel 139 may have a rough surface, an embossed surface, or a surface having a plurality of recesses.

### DETAILED DESCRIPTION

### Theory

### Leading Floss Line/Space/Panel

The leading floss line, as it is scraped against the user's tooth surface, cuts under the superficial tartar and food particles, peeling them away from the tooth surface.

As the cleaning head moves farther into the interdental space, the tartar and food particles peeled away from the tooth surface are caught in the space between the floss tape and the panel.

As the cleaning head is removed from the interdental space, a trailing edge of the panel encounters the tartar and food particles, and pushes them away from the gums, toward the crown of the tooth and out of the interdental space. The panel may have orifices that can collect or trap the tartar and food particles and remove them from the interdental space of the user's mouth. The panels may also be made of an embossed material which collects the debris which is then removed from the interdental spaces.

### Snapping

As mentioned above, when floss is forced through a narrow portion of spacing between the user's teeth, the user does not have time to react and reduce the force before the floss snaps through the tight section and cuts into the user's gums.

However, the current invention reduces or eliminates cutting of the gums by having a panel on the same cleaning head as the leading floss line. The leading edge of the panel must be positioned a distance away from the end ribbon that is no more than the distance between the location of the tightest gap and the gum line. This arrangement causes the leading edge of the panel to become wedged in the tight spot, slowing or stopping the motion of the flossing device and the end ribbon toward the user's gums. This reduces or prevents the end ribbon from cutting into the user's gums.

### Implementation

### Multiple Strands

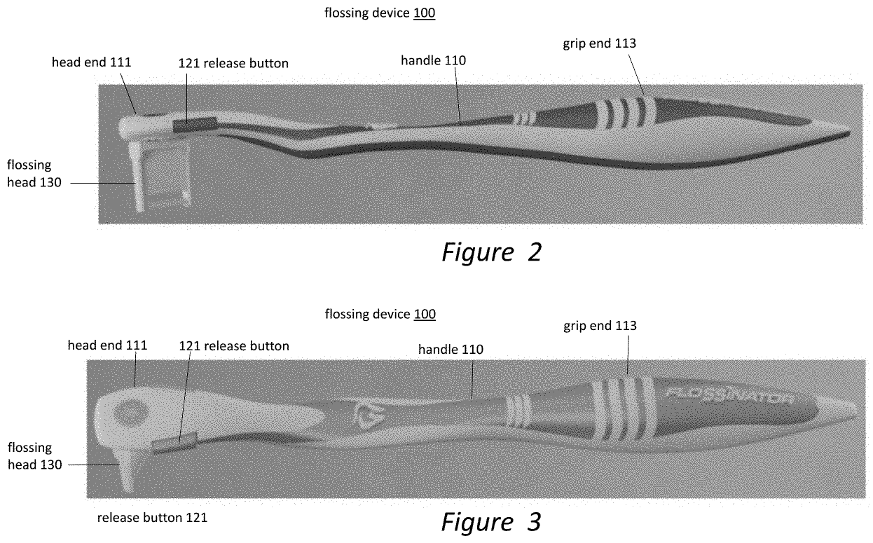

FIG. 2 is a view of a side of an embodiment of a novel flossing device 100, referred to as the “Flossinator”, according to the current invention. It includes a flossing head 130 attached to a head end 111 of a handle 110. Flossing head 130 may be fixed at an adjustable angle to allow alignment with interdental spaces between user's teeth.

The flossing head 130 is preferably designed to be removable and disposable.

FIG. 3 is a view of the back side of the embodiment of the novel flossing device 100 according to the current invention. Here, release buttons 121 are shown. When the release buttons 121 are pressed together by the user, flossing head 130 may be removed from the handle 110. Another flossing head 130 may then be snapped into place into handle 110. Any conventional locking mechanism may be used which sufficiently holds the flossing head 130 to allow for vigorous flossing.

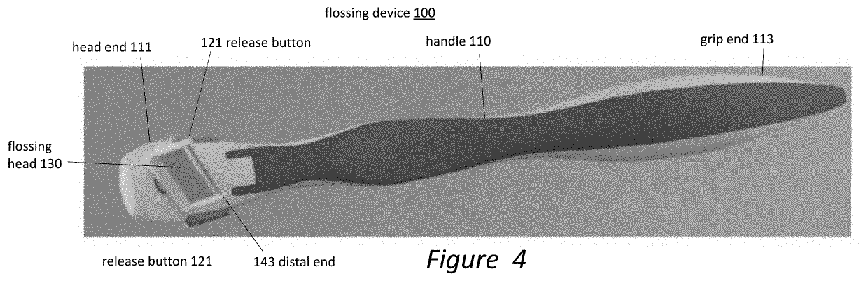

FIG. 4 is a view of the front side of an embodiment of the novel flossing device 100 according to the current invention. In this view, the flossing head 130 is shown with a distal end 143 of the flossing head 130 protruding out of the plane of the image. A proximal end 145 of the flossing head 130 shows the release buttons 121. The flossing head 130 is positioned at an angle relative to the handle.

### Pivoting Cleaning Head

The flossing head 130 is removably attached to the handle 110 at a pivot point. This allows the cleaning head to rotate to a fixed angle relative to the handle. This allows the user to clean surfaces that were previously inaccessible with a flossing string used manually.

There may be structures in the head which interact with the top of the flossing head 130 which allow it to be adjusted to an angle and held at that angle until moved to a different angle.

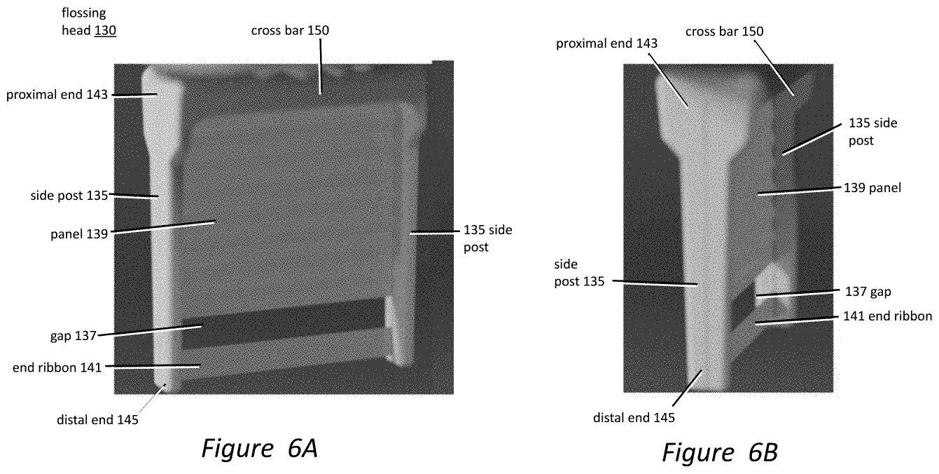

One such way of keeping the flossing head 130 at a fixed position is by having structures on the handle 110 and flossing head 130 which interact with each other. For example, on the front side of head end 111 of handle 110, there are a plurality of ridges having recesses between them at various angles radiating from a receiving recess in front side of head end 111. These recesses are constructed to receive a cross bar (150 of FIG. 6A). Force is required to rotate the cross bar 150 over the ridge until the cross bar 150 is seated in a recess between the ridges. This holds the flossing head 130 at this angle until a force great enough to rotate it over the ridges is again applied to the flossing head 130.

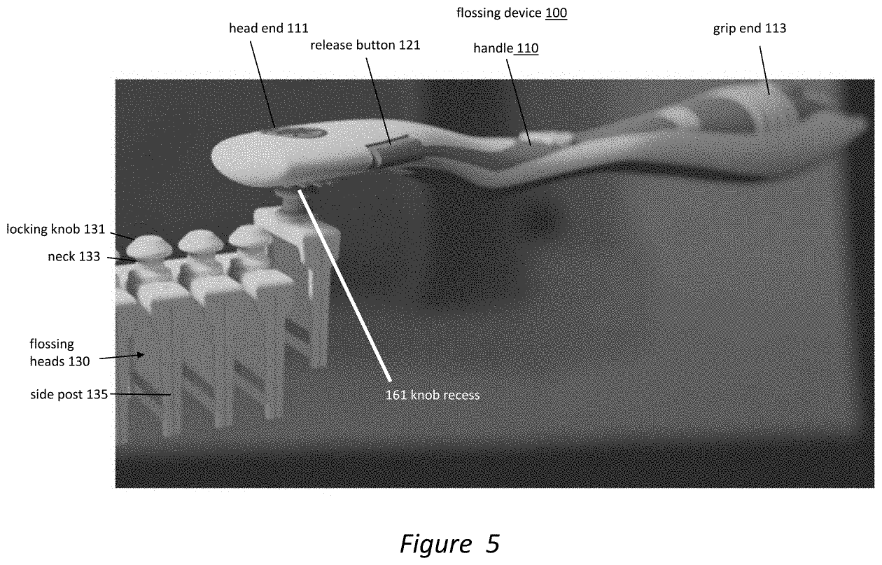

In an alternative embodiment, the locking knob (131 of FIG. 5), or neck (133 of FIG. 5) may be held by conventional means to hold the flossing head 130 at various angles relative to the handle 110.

FIG. 5 is a perspective view of an embodiment of a novel flossing device 100 according to the current invention as it attaches to a removable and disposable flossing head 130.

### Replaceable Head

In this embodiment, the cleaning heads 130 are single-use and are replaceable. The flossing head 130 preferably snaps into the handle 110 at the pivot point. When finished, the flossing head 130 is released by squeezing release buttons 121 on the sides of the head end 111. Many disposable cleaning heads 130 are shown here attached to each other. After a replacement flossing head 130 is attached to the handle 110, it is broken off the string of disposable cleaning heads 130. Here locking knob 131 and neck 133 can be seen. Locking knob 131 and neck 133 are inserted into a knob recess 161 in the bottom side of head end 111. A structure inside of head end 111 closes on and clamps to neck 133 thereby preventing the flossing head 130 from being unintentionally removed from the knob recess 161, but still allows flossing head 130 to pivot.

Each of the cleaning heads 130 employs a locking knob 131 and a neck 133 which fit into a knob recess 161 in the head end 111 of the handle 110.

FIG. 6A is a perspective view of an embodiment of a novel removable and disposable flossing head 130 compatible with the current invention. It shows the flossing head 130 having an end ribbon 141 which is stretched tight across two structural side posts 135 at the distal end 145 of the flossing head 130. This arrangement keeps the end ribbon 141 taut and eliminates the need for the user to hold the ribbon taut.

The flossing head 130 also has a panel 139 extending to a proximal end 143 adjacent the handle 110. This panel 139 may be comprised of a plurality of parallel ribbons, or a single structure.

Snapping

As indicated above, conventional flossing causes the floss to snap immediately after it passes between a tight space between the teeth. This typically causes cuts into the user's gums. The unique ribbon designs of the current invention eliminate this snapping effect, leading to smoother, more comfortable and more complete cleaning of teeth surfaces.

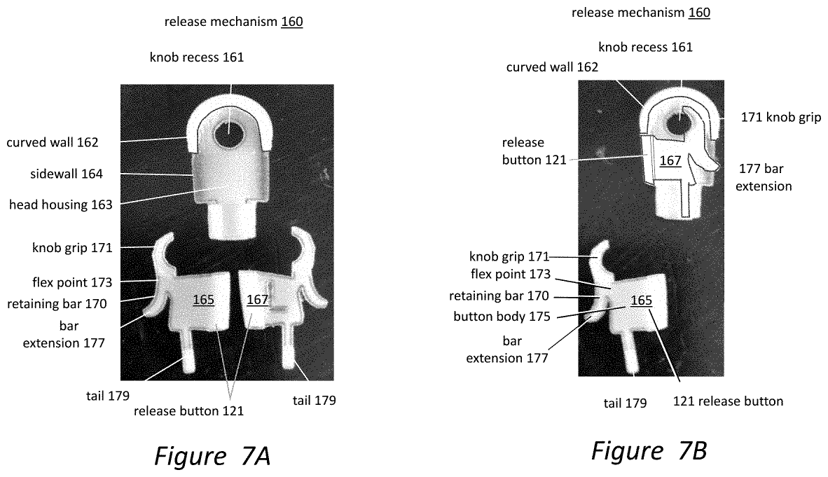

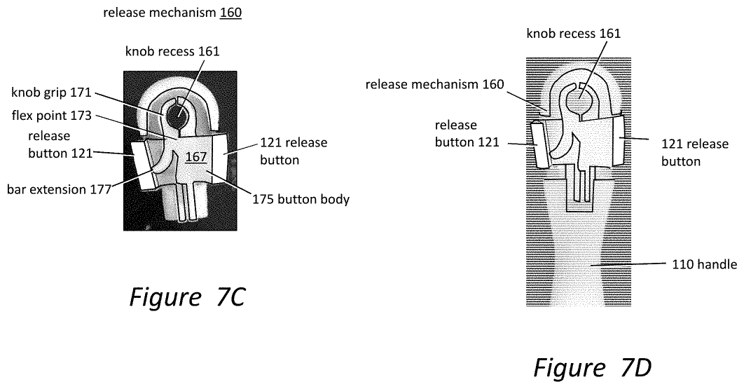

FIGS. 7A-7D show the release mechanism which holds and releases the flossing head shown in FIGS. 2, 3, 4, 5, 6A and 6B.

FIG. 7A shows an exploded view of the parts of one embodiment of a release mechanism 160 according to the current invention. This embodiment employs 3 separate pieces, the head housing 163, the right lever piece 165 and the left lever piece 167. These pieces fit together and function to secure a locking knob 131 and neck 133 of a flossing head 130, as shown in FIG. 5.

The head housing 163 has a curved wall 162 which extends out of the plane of the paper to a larger degree than the adjacent straight side walls 164 on either side of the head housing 163.

Therefore, when this is assembled, the lower side walls 164 create windows from which the release buttons 121 protrude outward.

In this embodiment, both the left and the right lever pieces 167, 165, respectively, are the same shape. This allows them both to be created on a single mold, saving manufacturing costs. (The left piece is on the right side of FIG. 7A-7D since the parts are positioned upside down.)

The left lever pieces each include a button body 175, connected to a retaining bar 170 at a flex point 173. The retaining bar is allowed to rotate about the flex point 173 relative to the button body 175. The retaining bar has a front end with a knob grip 171 sized and shaped to fit around the neck 133 of flossing head 130, retaining locking knob 131 when they extend through knob recess 161.

FIG. 7B shows the release mechanism of FIG. 7A partially assembled. In this figure, left lever piece 167 is installed in head housing 163, as it would be in the fully assembled release mechanism 160.

Release button 121 is shaped to rest on the side wall 164 and extend out of the head housing 163. Knob grip 171 is sized and shaped, in its relaxed state (without the release buttons 121 being pressed) to fit within the neck 133 of flossing head[[,]] and retain the locking knob 131 of flossing head 130 when in use.

FIG. 7C shows the release mechanism of FIG. 7A fully assembled. When release buttons 121 are pressed inward, toward the center of this figure, the button bodies 175 are allowed to slide over each other. As they move inward, they also move bar extensions 177 inward. Since the bar extensions 177 are part of the retaining bar 170, and the retaining bar is allowed to pivot around flex point 173, this causes knob grip 173 to move away from the center, outward and away from knob recess 161. Once both knob grips 173 move outward enough to clear locking knob 131, the flossing head 131 is released.

In its normal relaxed state, bar extension 177 rests against the inside of the release buttons 121, urging them outward, so that they may be pressed inward.

FIG. 7D shows the fully assembled release mechanism of FIG. 7C attached to a handle. In this figure, it is shown being pushed into handle 110. Under the true spirit of the invention, it may be attached to a pivoting handle, or attached by other conventional means.

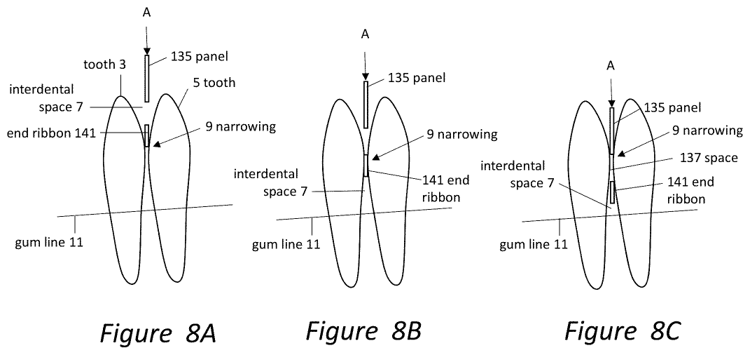

In FIG. 8A, the end ribbon 141 of the flossing head 130 is forced through the narrowing 9 between teeth 3, 5. Force “A” is applied to the proximal end of flossing head 130.

In FIG. 8B, end ribbon 141 is shown passing through the narrowing 9 between the teeth.

In FIG. 8C, end ribbon 141 continues to move through interdental space 7 toward the gum line 11. However, panel 139 then comes into contact with the narrowing 9, absorbing the force and slowing or stopping the motion of the end ribbon 141, panel 139 and the rest of flossing head 130 before end ribbon 141 inadvertently cuts into the user's gums.

The spacing between end ribbon 141 and the leading edge of panel 139 should be less than the distance between the narrowing 9 to the gum line 11. This can be calculated and implemented for adult teeth, or children's teeth which are not as long as adults' teeth.

More comfortable flossing leads to more frequent flossing, leading to better oral and overall health of the consumer.

### Space Between Ribbons

There is a space, or gap 137 between the end ribbon 141 and the panel 139 of the flossing head 130. This unique flossing design traps and removes tartar and food particles (collectively referred to as “debris”).

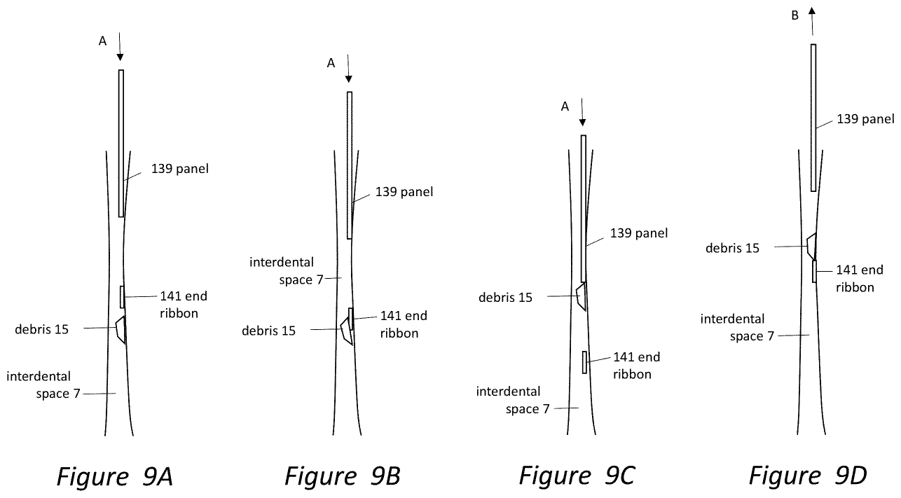

In FIG. 9A, the end ribbon 141 scrapes the tooth surface down to the user's gum line.

In FIG. 9B, as it scrapes, it encounters debris 15 from the surface of the user's tooth 5 and dislodges it.

In FIG. 9C, the dislodged debris 15 is prevented from traveling out of the interdental space 7 and attaching to other teeth by the panel 139. Panel 139 traps debris 15 in the gap 137 between the end ribbon 141 and the panel 139 as the end ribbon 141 and panel 139 are pressed into the interdental space 7 toward the gums, referred to as the “inward stroke”.

Referring now to FIG. 9D, as the panel 139 and end ribbon 141 are pulled out of the interdental space 7 (the “outward stroke”), the end ribbon 141 carries the dislodged debris 15 out, removing it with the flossing head 130 out of the interdental space 7. The open gap 137 between the leading ribbon 141 and the panel 139 collects debris 15 and traps it between the teeth 3, 5 and between end ribbon 141 and the distal end of panel 139. The debris 15 is carried with the panel 139 as it is removed from the interdental space 7.

This results in the leading ribbon 141 cleaning and maintaining the tooth surface all the way from the crown of the user's tooth, to below the gum line.

This embodiment is available in adult and children sizes.

### Ribbon/Panel Structure

Since the end ribbon 141 and panel 139 are intended to scrape the tartar and food particles away from the surface of the teeth 3, 5, it is beneficial if the material is embossed or employs irregularities on its surface. This will act as an abrasive surface and remove more tartar and food particles from the surface of the teeth.

Also, any holes or recesses will act to collect and carry the removed tartar and food particles out of the interdental spaces 7.

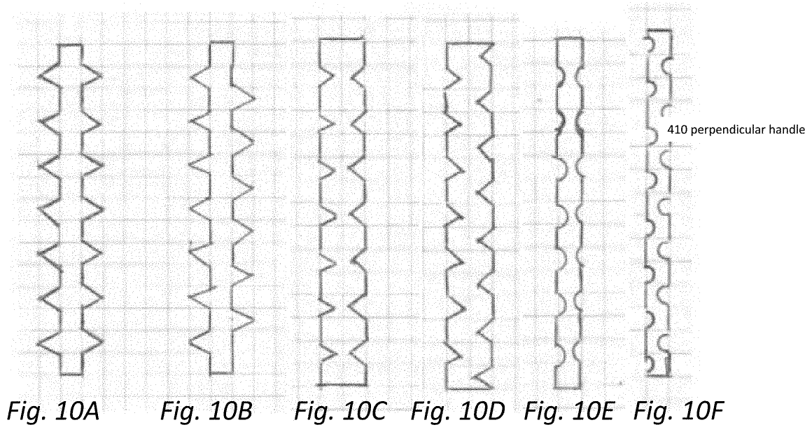

A number of different alternative embodiments of the panel are shown in FIGS. 10A-12B.

FIGS. 10A-10F illustrate various cross-sectional shapes that may be employed in the panel. Each of these would provide a more abrasive surface than a flat surface and therefore are more effective at scraping any debris from the surface of the teeth. These may be formed or molded in these shapes.

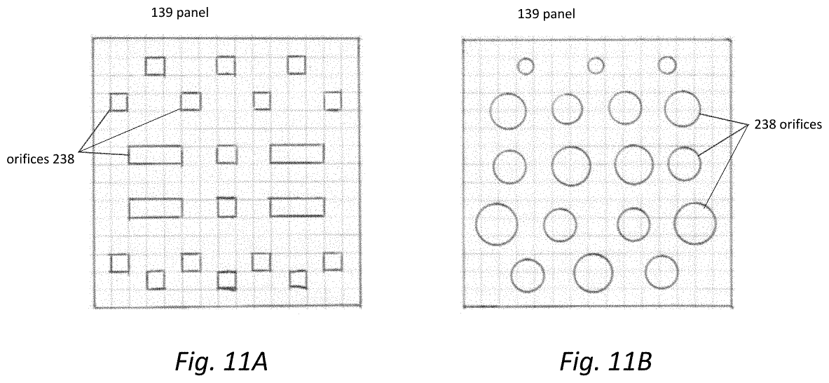

FIGS. 11A-11B illustrate panels used having die cut patterns. The panel 139 has a plurality of square orifices 238 cut out of it by a die. The orifices 238 act to roughen the surface and also to act as a collection space for debris which is removed from the teeth surfaces. The collected debris is removed with the panel 139.

Die cut panels 139 such as these can be manufactured easily allowing them to be mass produced.

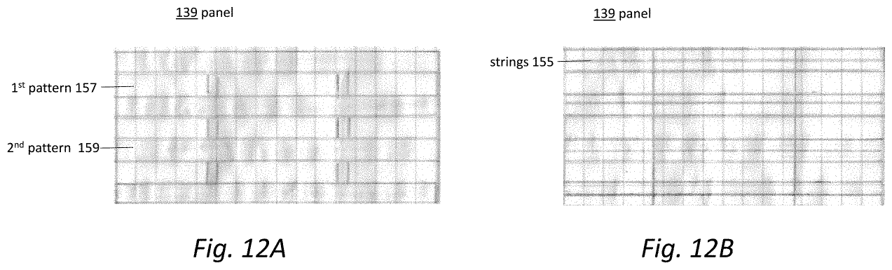

FIG. 12A illustrates alternative embodiment of a panel 139 having at least one embossed pattern. In this embodiment, there is a first pattern 157 and a parallel second pattern 159. One pattern may be a first embossed pattern, and the other can be another embossed pattern, or simply a flat surface. This embodiment provides a panel 139 with a rougher surface, allowing more efficient cleaning of teeth.

FIG. 12B illustrates alternative embodiment of a panel 139 having a plurality of parallel embedded strings 155. Panel 139 may be comprised of all strings 155, strings 155 and other flat materials, or strings 155 embedded in the other flat materials. The strings give the panel 139 additional tensile strength and also cause the surface to become more abrasive.

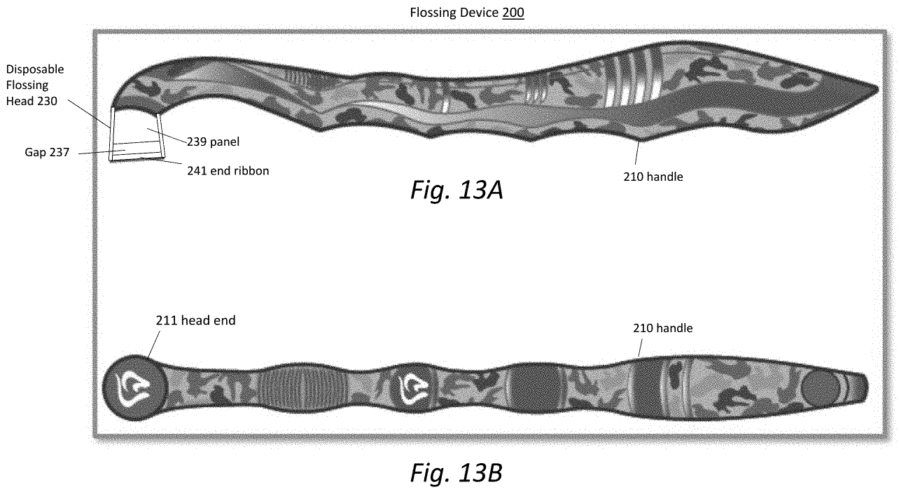

FIG. 13A is a side elevational view of another embodiment of a flossing device 200 according to the current invention. In this embodiment, a handle 210 is attached to a disposable flossing head 230, which is analogous to the cleaning head of the previously described flossing device 100. This includes a panel 239 analogous to the panel 139, end ribbon 241 analogous to the end ribbon 141, and an intermediate gap 237 analogous to the gap 137. This functions in a similar manner to the flossing device previously described.

FIG. 13B is a top plan view of the flossing device of FIG. 13A. A docking system (not shown) is housed in the head end 211 of flossing device 200.

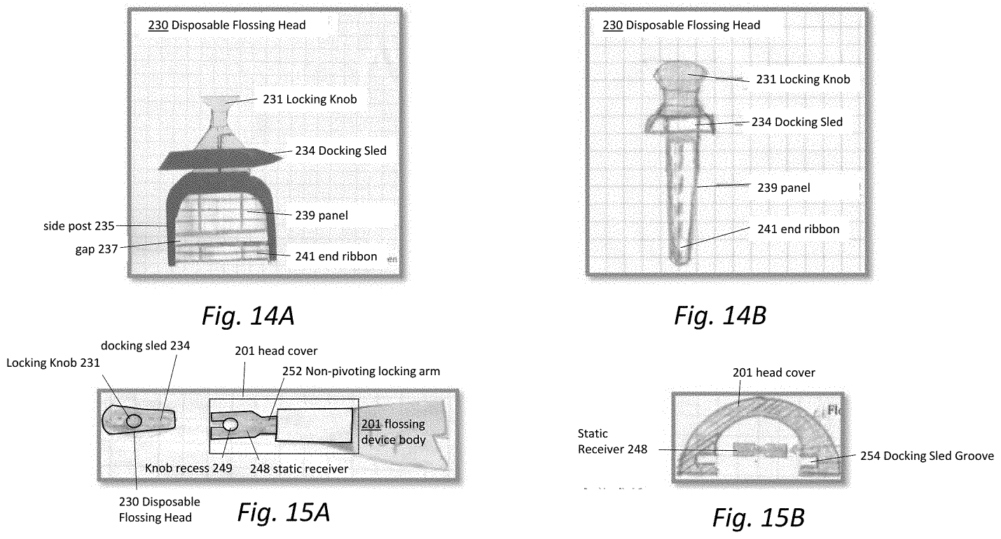

FIG. 14A is a front elevational view of an embodiment of a disposable flossing head 230 according to the current invention. It includes a locking knob 231 which is radially symmetric so that it may rotate within an orifice.

It includes two side posts 235 which hold a panel 239 and an end ribbon 241 between them. There is a gap 237 between these flossing screens. Disposable flossing head 230 functions in the same manner as flossing head 130 disclosed in the prior embodiments.

FIG. 14B is a side elevational view of the disposable flossing head of FIG. 14A. Many of the same elements are visible here from a different perspective.

FIG. 15A is a top plan view of another docking system with a portion of the body removed. A docking system 210 in the head end 211 of flossing device 200 is disclosed that receives and holds flossing head 130.

A docking sled 234 of the disposable flossing head 230 is pressed into the docking sled groove (254 of FIG. 15B).

A locking knob 231, which is analogous to the locking knob 131 of FIG. 5, is pressed into a slot of a static receiver 248 of a non-pivoting locking arm 252. The locking knob 231 is pushed inward to finally seat in knob recess 161.

FIG. 15B is a cross-sectional, front view of the docking system of FIG. 15A. In this view, the flossing device body 210 is shown enclosing the static receiver 248.

### Disposable Version

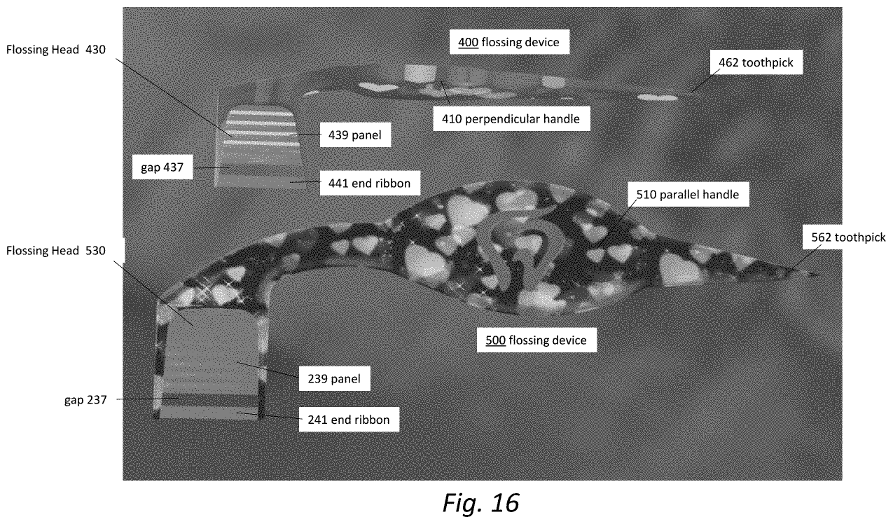

FIG. 16 shows two disposable embodiments of the flossing device 400, 500. Both employ a flossing head similar to that disclosed above.

Flossing device 400 has a flat handle 410 that is perpendicular to the flossing head 430. This may be ergonomically better for reaching certain interdental spaces. It includes a similar panel 439 spaced from the end ribbon 441 by a gap 447 which functions in a similar manner as the previously-described elements of the same names.

Flossing device 500 has a flat handle 510 which is parallel to the flossing head 530. This may be ergonomically better for reaching other interdental spaces.

Either or both may include a toothpick 462, 562.

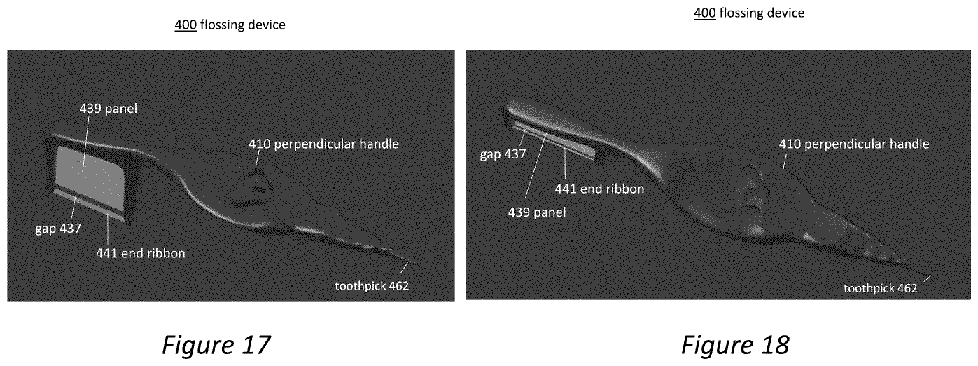

FIG. 17 is a perspective view of the flossing device 400 having a perpendicular handle 410 which is perpendicular to the panel 439, gap 437 and end ribbon 437, similar to that shown at the top of FIG. 16.

FIG. 18 is another perspective view of a flossing device of FIG. 17 having a perpendicular handle 410. This is viewed from a different viewpoint above the flossing device 400.

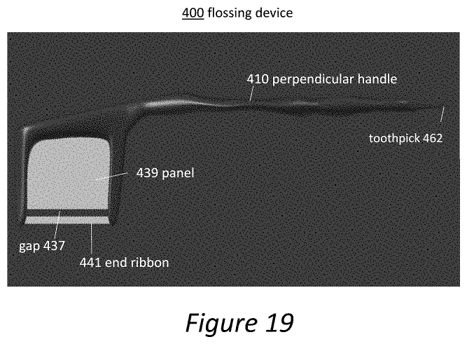

FIG. 19 is a side elevational view of the flossing device of FIGS. 17 and 18. Here the relationship between the panel 439, gap 437 and end ribbon 441 can be clearly seen.

Although a few examples have been shown and described, it will be appreciated by those skilled in the art that various changes and modifications might be made without departing from the scope of the invention, as defined in the appended claims.

What is claimed is:

1. A flossing device comprising:
a. a handle having a grip end and a head end;
b. a flossing head connected to the handle having:
i. a pair of elongated side posts each having a proximal end and a distal end;
ii. a cross bar attaching the proximal ends of the side posts;
iii. an end ribbon stretched between distal ends of the side posts; and
iv. a panel connected between the side posts but spaced away from the end ribbon.

2. The flossing device of claim 1 wherein the panel of the flossing device is comprised of:
a plurality of flossing ribbons.

3. The flossing device of claim 1 wherein the panel has a rough surface.

4. The flossing device of claim 1 wherein the panel has an embossed surface.

5. The flossing device of claim 1 wherein the panel has a surface having a plurality of recesses.

6. The flossing device of claim 1 wherein the flossing head can be fixed at a predetermined angle with respect to the handle.

7. The flossing device of claim 1 wherein the flossing head is removable.

8. The flossing device of claim 1 wherein the flossing head is replaceable.

9. The flossing device of claim 1 wherein the flossing head is disposable.

10. The flossing device of claim 1 wherein the end ribbon and panel of the flossing head are spaced apart less than half of the height of an average adult tooth.

11. The flossing device of claim 1 wherein the end ribbon and panel of the flossing head are spaced apart less than half of the height of an average child's tooth for a child's version of the flossing device.

12. The flossing device of claim 1 further comprising:
a. a neck attached to the flossing head;
b. a locking knob attached to the neck; and
c. release mechanism in the handle adapted to receive the locking knob and neck and retain them.

13. The flossing device of claim 12, wherein the release mechanism is adapted to releasably attach the flossing head to the handle.

15. The flossing device of claim 12, wherein the release mechanism comprises two lever pieces each comprising:
a. a release button;
b. a retaining bar attached to each release button at a flex point, comprising:
i. a knob grip at a first end, and
ii. a bar extension at a second end,
iii. wherein when the release buttons are pushed toward a center line of the handle, it causes the bar extensions to move towards the center line but causes the retaining bar to pivot at the flex point and cause the knob grips to move outward from a center line, releasing a flossing head.

16. A method of cleaning a user's teeth, comprising the steps of:
a. providing a flossing device having an elongated handle with a flossing head extending from the handle in a substantially perpendicular direction which is allowed to be rotated about a pivot and fixed at a desired angle;
b. wherein the cleaning head has an end ribbon stretched between two side posts spaced away from a panel extending between the side posts creating a gap;
c. adjusting a rotation angle of the flossing head to fit in at least one interdental space;
d. manipulating the handle to press the flossing head into the interdental space so as to remove debris and collect it in the gap; and
e. removing the flossing head from the interdental space so as to remove the debris collected in the gap.

17. The method of claim 16, after pressing the flossing head into the interdental space, further comprising the step of:
moving the flossing head to have the end ribbon and the panel slide against the tooth surface and scrape away additional debris.

18. The method of claim 16, further comprising the step of:
a. removing the used flossing head;
b. disposing the used flossing head; and
c. attaching a new flossing head.

19. A disposable flossing device, comprising:
a. a disposable handle having a grip end and a head end;
b. a disposable flossing head connected to the handle having:
i. a pair of elongated side posts each having a proximal end and a distal end;
ii. an end ribbon stretched between distal ends of the side posts; and
iii. a panel connected between the side posts but spaced away from the end ribbon.

20. The flossing device of claim 19 wherein the panel of the flossing device is comprised of:
a plurality of flossing ribbons.

21. The flossing device of claim 19 wherein the panel has a rough surface.

22. The flossing device of claim 19 wherein the panel has an embossed surface.

23. The flossing device of claim 19 wherein the panel has a surface having a plurality of recesses.
